(19) United States
(12) Patent Application Publication
(10) Pub. No.: US 2011/0017611 A1
(43) Pub. Date: Jan. 27, 2011

(54) OXYGEN-SCAVENGING MIXTURES

(75) Inventors: Edoardo Menozzi, Reggio Emilia (IT); Nazzareno Ruggeri, San Benedetto Val Di Sambro (IT); Claudia Pasti, Bologna (IT); Marcello Vitale, Castel D'Aiano (IT); Enrico Galfre, Cuneo (IT); Walter Fischer, Reinach (CH)

Correspondence Address: BASF Corporation;Patent Department, 500 White Plains Road, P.O. Box 2005, Tarrytown, NY, 10591, US

(73) Assignee: BASF SE, Tarrytown, NY (US)

(21) Appl. No.: 12/747,195

(22) PCT Filed: Dec. 15, 2008
(86) PCT No.: PCT/EP08/67538

§ 371 Date: Oct. 15, 2010

(30) Foreign Application Priority Data
Dec. 21, 2007 (EP) 07150374.2
Jan. 10, 2008 (EP) 08150149.6
May 9, 2008 (EP) 08155948.6

(51) Int. Cl. B01D 39/16

(52) U.S. Cl. 205/763

(57) ABSTRACT

An oxygen-scavenging mixture comprising the components (I) a nano-sized oxidizable metal component wherein the average particle size of the metal is 1 to 1000 nm and wherein the metal is unsupported or supported by a carrier material, (II) an electrolyte component, and (III) a non-electrolytic, acidifying component.

The present invention relates to an oxygen-scavenging mixture, a composition comprising a polymeric resin and said oxygen-scavenging mixture, an article containing said composition, a masterbatch containing said oxygen-scavenging mixture and the use of said oxygen-scavenging mixture in food packaging.

Oxygen-scavenging mixtures are for example described in U.S. Pat. No. 5,744,056, U.S. Pat. No. 5,885,481, U.S. Pat. No. 6,369,148, U.S. Pat. No. 6,586,514 and WO-A-96/40412.

The present invention relates in particular to an oxygen-scavenging mixture comprising the components
(I) a nano-sized oxidizable metal component wherein the average particle size of the metal is 1 to 1000 nm, preferably 1 to 900 nm, in particular 1 to 500 nm, for example 1 to 300 nm, and wherein the metal is unsupported or supported by a carrier material,
(II) an electrolyte component, and
(III) a non-electrolytic, acidifying component.

The average particle size may be determined by the Dynamic Light Scattering method as described in present Example 1 or by electron microscopy techniques such as SEM (Scanning Electron Microscopy) or TEM (Transmission Electron Microscopy), in particular in the case of metal supported nanoparticles or nanoparticles within a polymer matrix.

The weight ratio of the nano-sized oxidizable metal to the carrier material can be e.g. 1/100 to 50/100, in particular 1/100 to 30/100, for example 1/100 to 15/100.

The weight ratio of present Component (II) to present Component (III) can vary from e.g. 10/90 to 90/10 to provide effective oxygen scavenging. Preferably, at least one part by weight of an electrolyte component per 100 parts by weight of non-electrolytic, acidifying component is used and preferably two non-electrolytic, acidifying components can be used in the weight ratio of 1/1 to 10/1.

In order to achieve an advantageous combination of oxidation efficiency, low cost and ease of processing and handling, the sum of present Components (II) and (III) can be e.g. 20 to 500 parts by weight, in particular 30 to 130 parts by weight, per 10 parts of present Component (I); for example 20 to 100 parts by weight, per 10 parts of present Component (I), are most preferred.

The carrier material is for example a polymeric resin such as a polyolefin.

When the nano-sized metal is unsupported or supported by a carrier material different from a microporous material, the particle size of the nano-sized metal is e.g. 50 to 1000 nm, preferably 100 to 900 nm, in particular 100 to 500 nm, for example 100 to 300 nm.

According to a preferred embodiment of the present invention, the carrier material is a microporous material, for example one selected from the group consisting of zeolites, nano-clays, organic-metal frameworks and aluminosilicates. The nano-sized metal particles may be situated in and/or on the micropores. They are preferably attached to the surface of the micropores. Thus, products presenting oxygen scavenging properties that indicate extremely small dimension of the oxidizable metal particles and extremely high reactivity of these active particles are obtained.

The micropores can be in the form of e.g. channels, layers or cells.

The dimensions of the oxidizable metal particles being present in and/or on the micropores (preferably the micropores of a zeolite) can be extremely small, e.g. in the range of 1 to 150 nm, for example 1 to 100 nm, 1 to 50 nm, 1 to 30 nm or 50 to 150 nm.

The nano-sized oxidizable metal of the invention can be e.g. Al, Mg, Zn, Cu, Fe, Sn, Co or Mn, in particular Fe. Alloys or blends of such metals, or of such metals with other components, are also suitable. The metal particles being present in the micropores can be of any shape, such as spherical, octahedral, and cubic, in the form of rods or platelets and so on.

The nano-sized oxidizable metal particles can be used e.g. to partially replace alkaline metal ions on the surface or inside different microporous materials such as zeolites, nano-clays, organic-metal frameworks or aluminosilicates. Among several different matrices, zeolites are preferred as systems to be placed into contact with a modified oxygen atmosphere and used to absorb and scavenge oxygen molecules.

The present invention can, for example, use a zeolite containing, in the framework, silicon and optionally aluminum, where the exchangeable cations have been partly exchanged with oxidizable metals in order to obtain a selective oxygen scavenger.

Zeolites of the following formula (I) are of general interest:

M_{x/n}[(AlO₂)ₓ(SiO₂)_{y}]*wH₂O (I)

in which n is the charge of the cation M which is preferably an alkali metal or an alkaline earth metal; M is for example an element from the first or second main group (such as Li, Na, K, Mg, Ca, Sr or Ba) or Zn;
y:x is a number from 0.8 to 15, in particular from 0.8 to 1.2; and
w is a number from 0 to 300, in particular from 0.5 to 30.

Suitable structures can be found, for example, in the “Atlas of Zeolite” by W. M. Meier and D. H. Olson, Butterworth-Heinemann, 3^{rd} ed. 1992.

Preferred examples of zeolites are sodium aluminosilicates of the formulae

Na₁₂Al₁₂Si₁₂O₄₈*27H₂O[Zeolite A]; 1)

Na₆Al₆Si₆O₂₄*2NaX*7.5H₂O, X is e.g. OH, halogen or ClO₄[Sodalite]; 2)

Na₆Al₆Si₃₀O₇₂*24H₂O; 3)

Na₈Al₈Si₄₀O₉₆*24H₂O; 4)

Na₁₆Al₁₆Si₂₄O₈₀*16H₂O; 5)

Na₁₆Al₁₆Si₃₂O₉₆*16H₂O; 6)

Na₅₆Al₅₆Si₁₃₆O₃₈₄*250H₂O[Zeolite Y]; 7)

Na₈₆Al₈₆Si₁₀₆O₃₈₄*264H₂O[Zeolite X]. 8)

The Na atoms can also be partially or completely exchanged by e.g. Li, K, Mg, Ca, Sr or Zn atoms. Thus, further suitable examples are:

(Na,K)₁₀Al₁₀Si₂₂O₆₄*20H₂O; 9)

Ca_{4.5}Na₃[(AlO₂)₁₂(SiO₂)₁₂]*30H₂O; 10)

K₉Na₃[(AlO₂)₁₂(SiO₂)₁₂]*27H₂O. 11)

A preferred zeolite is the NaY Zeolite Na₅₆Si₁₃₆Al₅₆O₃₈₄ (Si/Al=2.43) with a particle size of e.g. 2-4 μm (available e.g. from Union Carbide®).

According to a particularly preferred embodiment of the present invention, Component (I) of the oxygen-scavenging mixture is a zeolite containing micropores with oxidizable metal particles, in particular iron particles, on the surface of the micropores and/or therein.

Component (I) can be prepared according to methods well known to those skilled in the art, for example as described in the present working examples.

The electrolyte component (Component (II)) comprises at least one material that substantially disassociates into positive and negative ions in the presence of moisture and promotes reactivity of the oxidizable metal component with oxygen. It also should be capable of being provided in granular or powder form and, for compositions to be used in packaging, of being used without adversely affecting products to be packaged. Examples of suitable electrolyte components include various electrolytic alkali, alkaline earth and transition metal halides, sulfates, nitrates, carbonates, sulfites and phosphates such as sodium chloride, potassium bromide, calcium carbonate, magnesium sulfate and cupric nitrate. Combinations of such materials also can be used.

A particularly preferred electrolyte component is sodium chloride.

The non-electrolytic, acidifying component (Component (III)) includes various non-electrolytic organic and inorganic acids and their salts. Examples of particular compounds include anhydrous citric acid, citric acid monosodium salt, ammonium sulfate, disodium dihydrogen pyrophosphate, also known as sodium acid pyrophosphate, sodium metaphosphate, sodium trimetaphosphate, sodium hexametaphosphate, citric acid disodium salt, ammonium phosphate, aluminum sulfate, nicotinic acid, aluminum ammonium sulfate, sodium phosphate monobasic and aluminum potassium sulfate. Combinations of such materials also can be used.

A particularly preferred non-electrolytic, acidifying component comprises sodium acid pyrophosphate and optionally a sodium acid phosphate (e.g. NaH₂PO₄) in a weight ratio effective to provide oxygen scavenging. Preferably, at least 1 part, in particular 1 to 10 parts, by weight of a sodium acid phosphate per 100 parts of sodium acid pyrophosphate is used.

The components of the present oxygen-scavenging mixtures are present in proportions effective to provide oxygen-scavenging effects. Preferably, at least 1 part by weight of electrolyte component plus acidifying component is present per 100 parts by weight of present Component (I), with the weight ratio of electrolyte component to non-electrolytic, acidifying component of e.g. 99:1 to 1:99, in particular 10:90 to 90:10. More preferably, at least about 10 parts of electrolyte plus non-electrolytic, acidifying components are present per 100 parts of present Component (I) to promote efficient usage of the latter for reaction with oxygen. In order to achieve an advantageous combination of oxidation efficiency, low cost and ease of processing and handling, 20 to 500, in particular 30 to 130 parts of electrolyte plus non-electrolytic, acidifying components per 10 parts of present Component (I) are most preferred.

According to a preferred embodiment, the oxygen-scavenging mixture may additionally contain (IV) a water-absorbant binder to further enhance oxidation efficiency of the oxidizable metal. The binder can serve to provide additional moisture which enhances oxidation of the metal in the presence of the promoter compounds. Water-absorbing binders suitable for use generally include materials that absorb at least about 5 percent of their own weight in water and are chemically inert. Examples of suitable binders include diatomaceous earth, boehmite, kaolin clay, bentonite clay, acid clay, activated clay, zeolite, molecular sieves, talc, calcined vermiculite, activated carbon, graphite, carbon black, and the like. It is also contemplated to utilize organic binders, examples including various water absorbent polymers as disclosed in EP-A-428,736. Mixtures of such binders also can be employed. Preferred binders are bentonite clay, kaolin clay, and silica gel.

If present, the water-absorbent binder preferably is used in an amount of e.g. 5 to 100 parts per 100 parts of present Component (I). When a binder component is used in compositions compounded into plastics, the binder most preferably is present in an amount of 10 to 50 parts per 100 parts of present Component (I) to enhance oxidation efficiency at loading levels low enough to ensure ease of processing.

A particularly preferred oxygen-scavenging mixture according to the invention comprises nano-sized iron unsupported or supported by a zeolite, sodium chloride and sodium acid pyrophosphate, with about 10 to about 150 parts by weight of sodium chloride plus sodium acid pyrophosphate being present per 100 parts by weight of nano-sized iron and the weight ratio of sodium chloride to sodium acid pyrophosphate being e.g. 10:90 to 90:10. Optionally, up to about 100 parts by weight of water absorbing binder per 100 parts by weight of the nano-sized iron may be present. Most preferably, the composition comprises nano-sized iron, 5 to 100 parts of sodium chloride and 5 to 70 parts of sodium acid pyrophosphate per 100 parts of nano-sized iron and e.g. 0 to 50 parts of binder per 100 parts of the nano-sized iron.

Another embodiment of the present invention relates to a composition comprising

(A) a polymeric resin, and
(B) an oxygen-scavenging mixture as defined above and optionally a conventional additive.

The oxygen-scavenging mixture may be preferably present in an amount of 1 to 50 parts, preferably in an amount of 1 to 30 parts and in particular in an amount of 1 to 15 parts or 2 to 5 parts, per 100 parts of the polymeric resin, and the conventional additive may be present in an amount of e.g. 0.001 to 10 parts, preferably in an amount of 0.01 to 5 parts and in particular in an amount of 0.05 to 2 parts, per 100 parts of the polymeric resin.

Examples of polymeric materials are

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).
   2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
   3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
   4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndio-tactic, isotactic, hemi-isotactic or atactic; where atactic polymers are preferred. Stereoblock polymers are also included.

5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.
6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes which contain ethylene oxide as a comonomer; polyacetals modified with thermoplastic polyurethanes, acrylates or MBS.
14. Polyphenylene oxides and sulfides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.
18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.
19. Polycarbonates and polyester carbonates.

### 20. Polyketones.

21. Polysulfones, polyether sulfones and polyether ketones.
22. Crosslinked polymers derived from aldehydes on the one hand and phenols, ureas and melamines on the other hand, such as phenol/formaldehyde resins, urea/formaldehyde resins and melamine/formaldehyde resins.
23. Drying and non-drying alkyd resins.
24. Unsaturated polyester resins derived from copolyesters of saturated and unsaturated dicarboxylic acids with polyhydric alcohols and vinyl compounds as crosslinking agents, and also halogen-containing modifications thereof of low flammability.
25. Crosslinkable acrylic resins derived from substituted acrylates, for example epoxy acrylates, urethane acrylates or polyester acrylates.
26. Alkyd resins, polyester resins and acrylate resins crosslinked with melamine resins, urea resins, isocyanates, isocyanurates, polyisocyanates or epoxy resins.
27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.
28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.
29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.
31. Aqueous emulsions of natural or synthetic rubber, e.g. natural latex or latices of carboxylated styrene/butadiene copolymers.

Any suitable polymeric resin of the above list into which an effective amount of the oxygen-scavenging mixture of this invention can be incorporated and that can be formed into a laminar configuration, such as film, sheet or a wall structure, can be used as the plastic resin in the compositions according to this aspect of the invention. Thermoplastic and thermoset resins can be preferably used. Examples of thermoplastic polymers include polyamides, such as nylon 6, nylon 66 and nylon 612, linear polyesters, such as polyethylene terephthalate, polybutylene terephthalate and polyethylene naphthalate, branched polyesters, polystyrenes, polycarbonate, polymers of unsubstituted, substituted or functionalized olefins such as polyvinyl chloride, polyvinylidene dichloride, polyacrylamide, polyacrylonitrile, polyvinyl acetate, polyacrylic acid, polyvinyl methyl ether, ethylene vinyl acetate copolymer, ethylene methyl acrylate copolymer, polyethylene, polypropylene, ethylene-propylene copolymers, poly(1-hexene), poly(4-methyl-1-pentene), poly(1-butene), poly(3-methyl-1-butene), poly(3-phenyl-1-propene) and poly(vinylcyclohexane). Homopolymers and copolymers are suitable as are polymer blends containing one or more of such materials. Thermosetting resins, such as epoxies, oleoresins, unsaturated polyester resins and phenolics also are suitable.

Preferred polymers are in particular thermoplastic resins having oxygen permeation coefficients greater than 2×10⁻¹² cm³ cm cm⁻² sec⁻¹ cm⁻¹ Hg as measured at a temperature of 20° C. and a relative humidity of 0% because such resins are relatively inexpensive, easily formed into packaging structures and, when used with the invented oxygen-scavenging mixture, can provide a high degree of active barrier protection to oxygen-sensitive products. Examples of these include polyethylene terephthalate and polyalpha-olefin resins such as high, low and linear low density polyethylene and polypropylene. Even relatively low levels of oxygen-scavenging mixture, e.g. 5 to 15 parts per 100 parts resin, can provide a high degree of oxygen barrier protection to such resins. Among these preferred resins, permeability to oxygen increases in the order polyethylene terephthalate, polypropylene, high density polyethylene, linear low density polyethylene and low density polyethylene, other things being equal. Accordingly, for such polymeric resins, oxygen scavenger loadings for achieving a given level of oxygen barrier effectiveness increase in like order, other things being equal.

In selecting a thermoplastic resin for use or compounding with the oxygen-scavenging mixture of the invention, the presence of residual antioxidant compounds in the resin can be detrimental to oxygen absorption effectiveness. Phenol-type antioxidants and phosphite-type antioxidants are commonly used by polymer manufacturers for the purpose of enhancing thermal stability of resins and fabricated products obtained therefrom. Specific examples of these residual antioxidant compounds include materials such as butylated hydroxytoluene, tetrakis(methylene(3,5-di-t-butyl-4-hydroxyhydro-cinnamate)methane and triisooctyl phosphite. Such antioxidants are not to be confused with the oxygen-scavenger components utilized in the present invention. Generally, oxygen absorption of the scavenger compositions of the present invention is improved as the level of residual antioxidant compounds is reduced. Thus, commercially available resins containing low levels of phenol-type or phosphite-type antioxidants, preferably less than about 1600 ppm, and most preferably less than about 800 ppm, by weight of the resin, are preferred (although not required) for use in the present invention. Examples are Dow Chemical Dowlex 2032® linear low density polyethylene (LLDPE); Union Carbide GRSN 7047® LLDPE; Goodyear PET “Traytuf” 9506 m®; and Eastman PETG 6763®. Measurement of the amount of residual antioxidant can be performed using high pressure liquid chromatography.

If desired, in addition one or more of the following conventional additives might be used in combination with the oxygen scavenger formulation; the list includes for example antioxidants, UV absorbers and/or further light stabilizers such as e.g.:

1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethyl-phenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.
2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.
3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
4. Tocopherols, for example α-tocopherol, β-tocopherol, γ-tocopherol, δ-tocopherol and mixtures thereof (vitamin E).
5. Hydroxylated thiodiphenyl ethers, for example 2, 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.
6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.
7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.
8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethyl benzene, 2,4,6-tris(3,5-di-tert-butyl-4-hydroxybenzyl)phenol.
10. Triazine compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)isocyanurate.
11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
12. Acylaminophenols, for example 4-hydroxylauranilide, 4-hydroxystearanilide, octyl N-(3,5-di-tert-butyl-4-hydroxyphenyl)carbamate.
13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.
15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxy-phenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).
18. Ascorbic acid (vitamin C)
19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenyl-amine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino-methylphenol, 2,4′-diaminodiphenylmethane, 4,4′-diaminodiphenylmethane, N,N,N′,N′-tetra-methyl-4,4′-diaminodiphenylmethane, 1,2-bis[(2-methylphenyl)amino]ethane, 1,2-bis(phenyl-amino)propane, (o-tolyl)biguanide, bis[4-(1,3′-dimethylbutyl)phenyl]amine, tert-octylated N-phenyl-1-naphthylamine, a mixture of mono- and dialkylated tert-butyl/tert-octyldiphenyl-amines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.
20. 2-(2′-Hydroxyphenyl)benzotriazoles, for example 2-(2′-hydroxy-5′-methylphenyl)-benzo-triazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonyl-ethyl)phenyl)benzotriazole, 2-(3′-tert-butyl-5′-[2-(2-ethylhexyloxy)carbonylethyl]-2′-hydroxy-phenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl)-phenyl]benzotriazole.
21. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.
22. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.
23. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-di-phenylacrylate.
24. Sterically hindered amines, for example carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-di-chloro-1,3,5-triazine, tris(2,2,6,6-tetramethyl-4-piperidyl)nitrilotriacetate, tetrakis(2,2,6,6-tetra-methyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethyl-piperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decane-2,4-dione, bis(1-octyl-oxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylene-diamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)-ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro-[4,5]decane, a reaction product of 7,7,9,9-tetramethyl-2-cycloundecyl-1-oxa-3,8-diaza-4-oxo-spiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine.
25. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.
26. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyl-oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[4-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethyl-phenyl)-1,3,5-triazine, 2-(2-hydroxy-4-hexyloxy)phenyl-4,6-diphenyl-1,3,5-triazine, 2-(2-hydrooxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.

When used in combination with resins, the electrolyte and non-electrolytic, acidifying components of the invented oxygen-scavenging mixtures, and any optional water-absorbent binder that may be used, are used in particulate or powder form. Particle sizes of at least 290 μm or smaller are preferred to facilitate melt-processing of oxygen-scavenger thermoplastic resin formulations. For use with thermoset resins for formation of coatings, particle sizes smaller than the thickness of the final coating are employed. The oxygen-scavenger mixture can be used directly in powder or particulate form, or it can be processed, for example by melt compounding or compaction-sintering, into pellets to facilitate further handling and use. The mixture of present Component (I), electrolyte component, non-electrolytic, acidifying component and optional water-absorbent binder can be added directly to a thermoplastic polymer compounding or melt-fabrication operation, such as in the extrusion section thereof, after which the molten mixture can be advanced directly to a film or sheet extrusion or coextrusion line to obtain monolayer or multilayer film or sheet in which the amount of oxygen-scavenging mixture is determined by the proportions in which the mixture and resin are combined in the resin feed section of the extrusion-fabrication line. Alternatively, the mixture of present Component (I), electrolyte component, non-electrolytic, acidifying component and optional binder can be compounded into masterbatch concentrate pellets, which can be further let down into packaging resins for further processing into extruded film or sheet, or injection molded articles such as tubs, bottles, cups, trays and the like.

The degree of mixing of present Component (I), electrolyte and non-electrolytic, acidifying components and, if used, optional binder component has been found to affect oxygen absorption performance of the oxygen-scavenging mixtures, with better mixing leading to better performance. Mixing effects are most noticeable at low electrolyte plus non-electrolytic, acidifying components to present Component (I) ratios and at very low and very high non-electrolytic, acidifying component to electrolyte component ratios. Below e.g. 10 parts by weight of electrolyte plus non-electrolytic, acidifying components per 100 parts by weight of present Component (I), or when the weight ratio of either the electrolyte or non-electrolytic, acidifying component to the other is less than about 10:90, the oxygen-scavenger components are preferably mixed by aqueous slurry mixing followed by oven drying and grinding into fine particles. Below these ratios, mixing by techniques suitable at higher ratios, such as by high-intensity powder mixing, as in a Henschel mixer or a Waring powder blender, or by lower intensity mixing techniques, as in a container on a roller or tumbler, may lead to variability in oxygen uptake, particularly when the mixtures are incorporated into thermoplastic resins and used in melt processing operations.

Other factors that may affect oxygen absorption performance of the invented oxygen-scavenging mixtures include surface area of articles incorporating the compositions, with greater surface area normally providing better oxygen absorption performance. The amount of residual moisture in the water-absorbant binder, if used, also can affect performance with more moisture in the binder leading to better oxygen absorption performance. However, there are practical limits on the amount of moisture that should be present in the binder because too much can cause premature activation of the oxygen-scavenger mixture as well as processing difficulties and poor aesthetics in fabricated products. When incorporated into thermoplastic resins and used for fabrication of articles by melt processing techniques, the nature of the resin also can have a significant effect. Thus, when the invented oxygen-scavenging mixtures are used with amorphous and/or oxygen permeable polymers such as polyolefins or amorphous polyethylene terephthalate, higher oxygen absorption is seen than when the compositions are used with crystalline and/or oxygen barrier polymers such as crystalline polyethylene terephthalate and EVOH.

When used with thermoplastic resins, the oxygen-scavenging mixtures can be incorporated directly into the resin in amounts effective to provide the desired level of oxygen-scavenging ability. When so-used, preferred oxygen scavenger levels will vary depending on the choice of resin, configuration of the article to be fabricated from the resin and oxygen-scavenging capability needed in the article. Use of resins with low inherent viscosity, e.g., low molecular weight resins, normally permits higher loadings of scavenger composition without loss of processability. Conversely, lesser amounts of oxygen-scavenger mixture may facilitate use of polymeric materials having higher viscosities. Preferably, at least 0.1 parts by weight of oxygen-scavenging mixture are used per 100 parts by of weight of resin. Loading levels above 200 parts per 100 parts of resin generally do not lead to gains in oxygen absorption and may interfere with processing and adversely affect other product properties. More preferably, loading levels of e.g. 0.2 to 150 parts, in particular 0.3 to 50 parts, per 100 parts of resin are used to obtain good scavenging performance while maintaining processibility. Loading levels of 0.3 to 20 parts per 100 parts of resin are particularly preferred for fabrication of thin films and sheets.

Preferred oxygen-scavenger resin compositions for fabrication of packaging articles comprise at least one thermoplastic resin and e.g. 2 to 50 parts, preferably 5 to 50 parts, by weight of oxygen-scavenging mixture per 100 parts by weight of resin, with the oxygen-scavenging mixture comprising nano-sized iron unsupported or supported by a zeolite, sodium chloride and sodium acid pyrophosphate. More preferably, e.g. 30 to 130 parts by weight of sodium chloride and sodium acid pyrophosphate per 10 parts by weight of nano-sized iron are present in the scavenging mixture and the weight ratio of sodium chloride to sodium acid pyrophosphate is e.g. 10:90 to 90:10. Up to e.g. 50 parts by weight of water-absorbent binder per 100 parts by weight of resin and oxygen-scavenger also can be included. Especially preferred compositions of this type comprise polypropylene, high, low or linear low density polyethylene or polyethylene terephthalate as the resin, e.g. 5 to 30 parts by weight of oxygen-scavenger per 100 parts by weight of resin. Preferred is e.g. 5 to 100 parts by weight of sodium chloride and 5 to 70 parts by weight of sodium acid pyrophosphate per 10 parts by weight of nano-sized iron and e.g. 0 to 50 parts by weight of binder per 100 parts by weight of nano-sized iron plus sodium chloride plus sodium acid pyrophosphate.

While the oxygen-scavenging mixture and resin can be used in a non-concentrated form for direct fabrication of scavenging sheets or films (i.e., without further resin dilution), it also is beneficial to use the oxygen-scavenging composition and resin in the form of a concentrate or masterbatch. When so-used, the ability to produce a concentrate with low materials cost weighs in favor of relatively high loadings of scavenger that will still permit successful melt compounding, such as by extrusion pelletization. Thus, concentrate compositions according to the invention preferably contain at least e.g. 10 parts by weight of oxygen-scavenging mixture per 100 parts by weight of resin and more preferably 30 to 150 parts per 100 parts of resin. Suitable resins for such oxygen-scavenging concentrate compositions include any of the thermoplastic polymer resins described herein. Low melt viscosity resins facilitate use of high scavenger loadings and typically are used in small enough amounts in melt fabrication of finished articles that the typically lower molecular weight of the concentrate resin does not adversely affect final product properties. Preferred carrier resins are polypropylene, high density, low density and linear low density polyethylenes and polyethylene terephthalate. Preferred among those are polypropylenes having melt flow rates of e.g. 1 to 40 g/10 min, polyethylenes having melt indices of e.g. 1 to 20 g/10 min and polyethylene terephthalates having inherent viscosities of e.g. 0.6 to e.g. 1 in phenol/trichloroethane.

It also is contemplated to utilize various components of the oxygen-scavenging mixture or combinations of such components to form two or more concentrates that can be combined with a thermoplastic resin and fabricated into an oxygen-scavenging product. An advantage of using two or more concentrates is that the electrolyte and non-electrolytic, acidifying components can be isolated from the present Component (I) until preparation of finished articles, thereby preserving full or essentially full oxygen-scavenging capability until actual use and permitting lower scavenger loadings than would otherwise be required. In addition, separate concentrates permit more facile preparation of differing concentrations of the electrolyte and non-electolytic, acidifying components and/or water absorbant binder with the present Component (I) and also enable fabricators to conveniently formulate a wide range of melt-processible resin compositions in which oxygen-scavenging ability can be tailored to specific end use requirements. Preferred components or combinations of components for use in separate concentrates are (1) acidifying component; (2) combinations of present Component (I) with water absorbing binder component; and (3) combinations of electrolyte and non-electolytic acidifying components.

A particularly preferred component concentrate is a composition comprising sodium acid pyrophosphate and a thermoplastic resin. Such a concentrate can be added in desired amounts in melt fabrication operations utilizing thermoplastic resin that already contains, or to which will be added, other scavenging components. Especially preferred are concentrates containing e.g. 10 to e.g. 150 parts by weight of sodium acid pyrophosphate per 100 parts by weight of resin, with polypropylene, polyethylenes and polyethylene terephthalate being most preferred resins.

Thus a further embodiment of the present invention is a masterbatch comprising

(A) a polymeric resin, and
(B) 30 to 150% by weight, based on the polymeric resin, of the oxygen-scavenging mixture as described herein.

Polymeric resins that can be used for incorporating the oxygen-scavenging mixtures into internal coatings of cans via spray coating and the like are typically thermoset resins such as epoxy, oleoresin, unsaturated polyester resins or phenolic based materials.

Another embodiment of the present invention is an article containing a composition as described above. The article may be a film, a laminate (e.g. a coextruded multilayer film), a sheet or a rigid or flexible package (e.g. a food packaging).

In more detail, these articles of manufacture comprise at least one melt-fabricated layer containing the oxygen-scavenging mixture as described above. Because of the improved oxidation efficiency afforded by the invented oxygen-scavenging mixtures, the scavenger-containing layer can contain relatively low levels of the scavenger. The articles of the present invention are well suited for use in flexible or rigid packaging structures. In the case of rigid sheet packaging according to the invention, the thickness of the oxygen-scavenging layer is preferably not greater than e.g. 2500 μm, and is most preferably in the range of 50 to 1300 μm. In the case of flexible film packaging according to the invention, the thickness of the oxygen scavenger layer is preferably not greater than e.g. 250 μm and, most preferably, 10 to 200 μm. Packaging structures according to the invention can be in the form of films or sheets, both rigid and flexible, as well as container or vessel walls and liners as in trays, cups, bowls, bottles, bags, pouches, boxes, films, cap liners, can coatings and other packaging constructions. Both monolayer and multilayer structures are contemplated.

The oxygen-scavenging mixture and resin of the present invention afford active-barrier properties in articles fabricated therefrom and can be melt processed by any suitable fabrication technique into packaging walls and articles having excellent oxygen barrier properties that can avoid to include layers of costly gas barrier films such as those based on EVOH, PVDC, metallized polyolefin or polyester, aluminum foil, silica coated polyolefin and polyester, etc. The oxygen-scavenger articles of the present invention also provide the additional benefit of improved recyclability. Scrap or reclaim from the oxygen-scavenging resin can be easily recycled back into plastic products without adverse effects. In contrast, recycle of EVOH or PVDC gas barrier films may cause deterioration in product quality due to polymer phase separation and gelation occurring between the gas barrier resin and other resins making up the product. Nevertheless, it also is contemplated to provide articles, particularly for packaging applications, with both active and passive oxygen barrier properties through use of one or more passive gas barrier layers in articles containing one or more active barrier layers according to the invention. Thus, for some applications, such as packaging for food for institutional use and others calling for long shelf-life, an oxygen-scavenging layer according to the present invention can be used in conjunction with a passive gas barrier layer or film such as those based on EVOH, PVDC, metallized polyolefins or aluminum foil.

The present invention is also preferably directed to a packaging wall containing at least one layer comprising the oxygen-scavenging mixture and resin described above. It should be understood that any packaging article or structure intended to completely enclose a product will be deemed to have a “packaging wall,” as that term is used herein, if the packaging article comprises a wall, or portion thereof, that is, or is intended to be, interposed between a packaged product and the atmosphere outside of the package and such wall or portion thereof comprises at least one layer incorporating the oxygen-scavenging mixture of the present invention. Thus, bowls, bags, liners, trays, cups, cartons, pouches, boxes, bottles and other vessels or containers which are intended to be sealed after being filled with a given product are covered by the term “packaging wall” if the oxygen-scavenging composition of the invention is present in any wall of such vessel (or portion of such wall) which is interposed between the packaged product and the outside environment when the vessel is closed or sealed. One example is where the oxygen-scavenging composition of the invention is fabricated into, or between, one or more continuous thermoplastic layers enclosing or substantially enclosing a product. Another example of a packaging wall according to the invention is a monolayer or multilayer film containing the present oxygen-scavenging mixture used as a cap liner in a beverage bottle (i.e., for beer, wine, fruit juices, etc.) or as a wrapping material.

An attractive active-barrier layer is generally understood as one in which the kinetics of the oxidation reaction are fast enough, and the layer is thick enough, that most of the oxygen permeating into the layer reacts without allowing a substantial amount of the oxygen to transmit through the layer. Moreover, it is important that this “steady state” condition exist for a period of time appropriate to end use requirements before the scavenger layer is spent. The present invention affords this steady state, plus excellent scavenger longevity, in economically attractive layer thicknesses, for example, less than e.g. 2500 μm in the case of sheets for rigid packaging, and less than e.g. 250 μm in the case of flexible films. For rigid sheet packaging according to the present invention, an attractive scavenger layer can be provided in the range of 250 to 750 μm, while for flexible film packaging, layer thicknesses of 20 to 200 μm are attractive. Such layers can function efficiently with as little as e.g. 2 to 10 weight % of oxygen-scavenger mixture based on weight of the scavenger layer.

In fabrication of packaging structures according to the invention, it is important to note that the oxygen-scavenging resin composition of the invention is substantially inactive with respect to chemical reaction with oxygen so long as the water activity of the composition is not sufficient. In contrast, the composition becomes active for scavenging oxygen when the water activity reaches a particularly level. Water activity is such that, prior to use, the invented packaging articles can remain substantially inactive in relatively dry environments without special steps to maintain low moisture levels. However, once the packaging is placed into use, most products will have sufficient moisture to activate the scavenger composition incorporated in the walls of the packaging article.

To prepare a packaging wall according to the invention, an oxygen-scavenging resin formulation is used or the oxygen-scavenging mixture, or its components or concentrates thereof, is compounded into or otherwise combined with a suitable packaging resin whereupon the resulting resin formulation is fabricated into sheets, films or other shaped structures. Extrusion, coextrusion, blow molding, injection molding and any other sheet, film or general polymeric melt-fabrication technique can be used. Sheets and films obtained from the oxygen-scavenger composition can be further processed, e.g. by coating or lamination, to form multilayered sheets or films, and then shaped, such as by thermoforming or other forming operations, into desired packaging walls in which at least one layer contains the oxygen scavenger. Such packaging walls can be subjected to further processing or shaping, if desired or necessary, to obtain a variety of active-barrier end-use packaging articles. The present invention reduces the cost of such barrier articles in comparison to conventional articles which afford barrier properties using passive barrier films.

As a preferred article of manufacture, the invention provides a packaging article comprising a wall, or combination of interconnected walls, in which the wall or combination of walls defines an enclosable product-receiving space, and wherein the wall or combination of walls comprises at least one wall section comprising an oxygen-scavenging layer comprising (i) a polymeric resin, preferably a thermoplastic resin or a thermoset resin and most preferably a thermoplastic resin selected from the group consisting of polyolefins, polystyrenes and polyesters; (ii) a nano-sized oxidizable metal unsupported or supported by a zeolite, preferably comprising at least one member selected from the group consisting of Al, Mg, Zn, Cu, Fe, Sn, Co or Mn, and most preferably 0.1 to 100 parts of nano-sized iron per 100 parts by weight of the resin; (iii) an electrolyte component and a solid, non-electrolytic, acidifying component which in the presence of water has a pH of less than 7, with e.g. 5 to about 150 parts by weight of such components per 10 parts by weight of nano-sized iron preferably being present and the weight ratio of the non-electrolytic, acidifying component to electrolyte component preferably being about 5/95 to about 95/5; and, optionally, a water-absorbent binder. In such articles, sodium chloride is the most preferred electrolyte component and sodium acid pyrophosphate is most preferred as the non-electrolytic, acidifying component, with the weight ratio of sodium acid pyrophosphate to sodium chloride most preferably ranging from 10/90 to 90/10.

A particularly attractive packaging construction according to the invention is a packaging wall comprising a plurality of thermoplastic layers adhered to one another in bonded laminar contact wherein at least one oxygen-scavenging layer is adhered to one or more other layers which may or may not include an oxygen-scavenging composition. It is particularly preferred, although not required, that the thermoplastic resin constituting the major component of each of the layers of the packaging wall be the same, so as to achieve a “pseudo-monolayer”. Such a construction is easily recyclable.

An example of a packaging article using the packaging wall described above is a two-layer or three-layer dual ovenable tray made of crystalline polyethylene terephthalate (“C-PET”) suitable for packaging pre-cooked single-serving meals. In a three-layer construction, an oxygen-scavenging layer of 250 to 500 μm thickness is sandwiched between two non-scavenging C-PET layers of 70 to 250 μm thickness. The resulting tray is considered a “pseudo-monolayer” because, for practical purposes of recycling, the tray contains a single thermoplastic resin, i.e., C-PET. Scrap from this pseudo-monolayer tray can be easily recycled because the scavenger in the center layer does not detract from recyclability. In the C-PET tray, the outer, non-scavenging layer provides additional protection against oxygen transmission by slowing down the oxygen so that it reaches the center layer at a sufficiently slow rate that most of the ingressing oxygen can be absorbed by the center layer without permeating through it. The optional inner non-scavenging layer acts as an additional barrier to oxygen, but at the same time is permeable enough that oxygen inside the tray may pass into the central scavenging layer. It is not necessary to use a three layer construction. For example, in the above construction, the inner C-PET layer can be eliminated. A tray formed from a single oxygen scavenging layer is also an attractive construction.

The pseudo-monolayer concept can be used with a wide range of polymeric packaging materials to achieve the same recycling benefit observed in the case of the pseudo-monolayer C-PET tray. For example, a package fabricated from polypropylene or polyethylene can be prepared from a multilayer packaging wall (e.g., film) containing the oxygen-scavenging composition of the present invention. In a two-layer construction the scavenger layer can be an interior layer with a non-scavenging layer of polymer on the outside to provide additional barrier properties. A sandwich construction is also possible in which a layer of scavenger-containing resin, such as polyethylene, is sandwiched between two layers of non-scavenging polyethylene. Alternatively, polypropylene, polystyrene or another suitable resin can be used for all of the layers.

Various modes of recycle may be used in the fabrication of packaging sheets and films according to the invention. For example, in the case of manufacturing a multilayer sheet or film having a scavenging and non-scavenging layer, reclaim scrap from the entire multilayer sheet can be recycled back into the oxygen scavenging layer of the sheet or film. It is also possible to recycle the multilayer sheet back into all of the layers of the sheet.

Packaging walls and packaging articles according to the present invention may contain one or more layers which are foamed. Any suitable polymeric foaming technique, such as bead foaming or extrusion foaming, can be utilized. For example, a packaging article can be obtained in which a foamed resinous layer comprising, for example, foamed polystyrene, foamed polyester, foamed polypropylene, foamed polyethylene or mixtures thereof, can be adhered to a solid resinous layer containing the oxygen-scavenging composition of the present invention. Alternatively, the foamed layer may contain the oxygen-scavenging composition, or both the foamed and the non-foamed layer can contain the scavenging composition. Thicknesses of such foamed layers normally are dictated more by mechanical property requirements, e.g. rigidity and impact strength, of the foam layer than by oxygen-scavenging requirements.

Packaging constructions such as those described above can benefit from the ability to eliminate costly passive barrier films. Nevertheless, if extremely long shelf life or added oxygen protection is required or desired, a packaging wall according to the invention can be fabricated to include one or more layers of EVOH, nylon or PVDC, or even of metallized polyolefin, metallized polyester, or aluminum foil. Another type of passive layer which may be enhanced by an oxygen-scavenging resin layer according to the present invention is silica-coated polyester or silica-coated polyolefin. In cases where a multilayer packaging wall according to the invention contains layers of different polymeric compositions, it may be preferable to use adhesive layers such as those based on ethylene-vinyl acetate copolymer or maleated polyethylene or polypropylene, and if desired, the oxygen-scavenger of the present invention can be incorporated in such adhesive layers. It is also possible to prepare the oxygen-scavenging composition of the present invention using a gas barrier resin such as EVOH, nylon or PVDC polymer in order to obtain a film having both active and passive barrier properties.

While the focus of one embodiment of the invention is upon the incorporation of the oxygen-scavenging mixture directly into the wall of a container, the oxygen-scavenging mixtures also can be used in packets, as a separate inclusion within a packaging article where the intent is only to absorb headspace oxygen.

A primary application for the oxygen-scavenging resin, packaging walls, and packaging articles of the invention is in the packaging of perishable foods. For example, packaging articles utilizing the invention can be used to package milk, yogurt, ice cream, cheeses; stews and soups; meat products such as hot dogs, cold cuts, chicken, beef jerky; single-serving pre-cooked meals and side dishes; homemade pasta and spaghetti sauce; condiments such as barbecue sauce, ketchup, mustard, and mayonnaise; beverages such as fruit juice, wine, and beer; dried fruits and vegetables; breakfast cereals; baked goods such as bread, crackers, pastries, cookies, and muffins; snack foods such as candy, potato chips, cheese-filled snacks; peanut butter or peanut butter and jelly combinations, jams, and jellies; dried or fresh seasonings; and pet and animal foods; etc. The foregoing is not intended to be limiting with respect to the possible applications of the invention. Generally speaking, the invention can be used to enhance the barrier properties in packaging materials intended for any type of product which may degrade in the presence of oxygen.

Still other applications for the oxygen-scavenging compositions of this invention include the internal coating of metal cans, especially for oxygen-sensitive food items such as tomato-based materials, baby food and the like. Typically the oxygen-scavenging composition can be combined with polymeric resins such as thermosets of epoxy, oleoresin, unsaturated polyester resins or phenolic based materials and the material applied to the metal can by methods such as roller coating or spray coating.

Thus, a further embodiment of the invention is the use of a mixture comprising components (I) to (III) as defined above as oxygen-scavenger in food packaging.

Preferably, the oxygen-scavenging mixture according to the present invention may be used to manufacture plastic films, sheets, bags, bottles, styrofoam cups, plates, utensils, blister packages, boxes, package wrappings, plastic fibers, tapes, twine agricultural films, disposable diapers, disposable garments, shop bags, refuse sacks, cardboard boxes, filtering devices (for refrigerators) and the like. The articles may be manufactured by any process available to those of ordinary skill in the art including, but not limited to, extrusion, extrusion blowing, film casting, film blowing, calendering, injection molding, blow molding, compression molding, thermoforming, spinning, blow extrusion and rotational casting. In particular, this is of interest in the area of packaging such as films, boxes, filters, labels, bags and sachets. The rate of the gas decomposition can be adjusted by simply changing the concentration of the oxidation additives.

An overview of the various applications which are possible for the present oxygen-scavenging mixtures are described for example in U.S. Pat. No. 5,744,056, U.S. Pat. No. 5,885,481, U.S. Pat. No. 6,369,148 and U.S. Pat. No. 6,586,514, which are incorporated by reference herein.

The examples below illustrate the invention in greater detail. All percentages and parts mentioned in this application are by weight, unless stated otherwise.

### EXAMPLE 1

12.27 g of FeCl₃ are dissolved in 1.5 l of H₂O and stirred at 400 rpm at room temperature under N₂ atmosphere. 37.83 g of NaBH₄ dissolved in 1.5 L of H₂O are added to this yellow solution over 30 minutes. During the addition the solution turned black due to the formation of Fe⁽⁰⁾ particles. The stirring is continued for an additional 30 minutes after all the NaBH₄ solution has been added. Finally, the Fe⁽⁰⁾ particles, agglomerating, are filtered off and washed with H₂O and diluted EtOH solution (5%).

The Fe⁽⁰⁾ nanoparticles obtained as described above are analyzed by dynamic light scattering (DLS; ZetaSizer—Malvern Instruments®). Particle sizes of 0.6 nm up to 10 μm can be measured by this method. The Fe⁽⁰⁾ nanoparticles are diluted in EtOH (an organic solvent such as MeOH, hexane, toluene, tetrahydrofuran (THF) or CH₂Cl₂ is also suitable). The final sample concentration is about 2% (generally the concentration may be in the range between 10.0% and 0.01%). The nanoparticle dispersions are sonicated for 10 minutes before DLS measures (Dynamic Light Scattering), and each recorded value is the average of 15 measurements. The Fe⁽⁰⁾ nanoparticles are found to have an average particle size of 300 nm.

The Fe nanoparticles thus produced are employed in the procedures described in Examples 2 and 3.

### EXAMPLE 2

4.5 g of Fe particles produced as described in Example 1 are suspended in 500 ml of toluene. The suspension is heated at 110° C. under N₂ and 50 g of polyethylene are added in small portions. The suspension is stirred under N₂ for one hour, then evaporated to dryness under reduce pressure, yielding 54 g of final iron-functionalized (8.2% Fe by weight measured by ICP-OES (Inductively Coupled Plasma—Optical Emission Spectrometer, Perkin Elmer Optima Series 4200DV®) polyethylene product.

### EXAMPLE 3

NaCl, Na₂H₂P₂O₇ and NaH₂PO₄ are mixed with Riblene GP20® low density polyethylene so that the ratios NaCl/Na₂H₂P₂O₇/NaH₂PO₄ are 1/0.92/0.08 by weight, and the final concentration of NaCl is 1.2% by weight. 3.0% of the Fe-functionalized polyethylene product of Example 2, resulting in 0.25% of Fe by weight measured by ICP, is added. The mixture is extruded with an OMC pilot double screw extruder (model EBV 19/25, with a 19 mm screw diameter and 1:25 ratio). 50 micron-thick films are prepared using a Formac Blow Extruder® (model Lab25, with a 22 mm screw diameter and 1:25 ratio). Several aliquots of film are then exposed to air (20.7% O₂) in 500 ml sealed flasks provided with a septum that allowed portions of the inside atmosphere to be drawn for analysis at several intervals using a syringe, in the presence of 15 ml of water contained in a vial inside the flasks. Oxygen concentration measures are carried out using a Mocon Pac Check 450 Head Space Analyzer® over 28 days. The actual iron concentrations in the samples tested are finally measured by ICP. The results in terms of cc O₂/g of Fe are given in Table 1.

TABLE 1

| Average cc O₂/g Fe | Standard deviation |
|---|---|
| 170 | 20 |

The amount of oxygen adsorbed by the test samples is determined from the change in the oxygen concentration in the head space of a sealed glass container. The test container has a headspace volume of about 500 ml and contains atmospheric air so that about 100 ml of oxygen are available for reaction with the iron nanoparticles. Test samples having Fe-functionalized polyethylene content of about 3.0% are tested. In the example oxygen scavenger component percentages are in weight percents based on total weight of the film composition.

### Detailed Description of Oxygen Uptake Method

From the extruded films 1-2 cm from the edges are trimmed and discarded. The film thickness is measured and 4.00 grams of film (±0.01 g) are weighted. The film is folded accordion style and placed in a clean 500 ml sealed glass container. A vial containing 15 ml of deionized water is added to produce 100% relative humidity inside the glass container.

The oxygen content in the ambient air on day 0 (i.e. equal to the initial oxygen content in the sealed glass container) is tested and recorded.

The glass containers with test films and water vials are stored at 22° C. (generally, room temperature) for 28 days.

The oxygen content in the sealed glass containers using a Mocon Oxygen Analyzer on day 28 are tested and recorded.

Based on the measured oxygen concentration remaining in the sealed glass container, it is possible to calculate the volume of oxygen absorbed per gram of Oxygen Scavenger using the following formula.

Oxygen absorbed (cc/g)={(% O₂)ᵢ−(% O₂)_{f}}*0.01*Vⱼ/(W_{F}*W_{S}/W_{B})

where:
(% O₂)ᵢ Initial oxygen concentration in the sealed glass container (%)
(% O₂)_{f} Oxygen concentration in the sealed glass container at day of test (%)
0.01: Conversion factor
Vⱼ: Free air volume of the sealed glass container (cc) (total volume of the sealed glass container less space occupied by vial and film, typically 440 cc)
W_{F}: Weight of film placed into the glass container (g) (typically 4.0 g)
W_{S}: Weight of Oxygen Scavenger used to make blend (g)
W_{B}: Total weight of blend (g)

### EXAMPLE 4

100.0 g of FeSO₄*7H₂O are dissolved in 2.0 l of H₂O and stirred at room temperature under N₂ atmosphere. 100.0 g of zeolite (Na Y-CBV100 or HSZ320) are added to the green iron solution. The suspension is stirred for 48 hours at 40° C., then the slightly brown powder is filtered off and washed with H₂O and EtOH. The procedure is repeated until a desired degree of iron loading inside the zeolite has been achieved. The Fe⁽²⁺⁾ functionalized Zeolite produced is employed in the procedure described in Example 5.

### EXAMPLE 5

75.0 g of Fe⁽²⁺⁾ functionalized Zeolite produced as described in Example 4 is suspended in 500 ml of H₂O and stirred at room temperature under N₂ atmosphere. 5.07 g of NaBH₄ are added in small portions. During the addition the solution turned gray due to the formation of Fe⁽⁰⁾ nanoparticles on and/or in the zeolite micropores. The suspension is stirred under N₂ for two hour, filtered off, washed with H₂O and acetone. The powder is dried under reduce pressure at 90° C. for 16 hours, yielding 67 g of Fe⁽⁰⁾-functionalized Zeolite. (6.9% Fe by weight measured by ICP-OES (Inductively Coupled Plasma—Optical Emission Spectrometer, Perkin Elmer Optima Series 4200DV®). The Fe⁽⁰⁾ nanoparticles have an average particle size of 100 nm determined by Scanning Electron Microscopy.

### EXAMPLE 6

572 mg of Fe⁽⁰⁾-zeolite (6.9% Fe by weight) of Example 5 are mixed with 40 mg of NaCl and 20 mg of Na₂H₂P₂O₇ in 1 ml of H₂O. The mixture is then exposed to air (20.7% O₂ concentration) in a 100 ml sealed flask provided with a septum that allows portions of the inside atmosphere to be drawn for analysis at several intervals using a syringe. Oxygen concentration measurements are carried out using a Mocon Pac Check 450® head space analyzer. The samples are not stirred or shaken during the course of the experiments. 1.0 ml of deionized H₂O is added through the silicon septum in the sealed flask with a syringe and oxygen scavenger activity as cc O₂/g of Fe after 48 hrs of reaction (measured from the moment when water is added to the system) is determined. The result is shown in Table 2.

TABLE 2

| cc O₂/g Fe in the Zeolite*) | Standard deviation |
|---|---|
| 255 | 40 |

*)Volume of oxygen absorbed per g Fe as average of three experiments (Details are explained in Example 3.)

### EXAMPLE 7

729 mg of Fe⁽⁰⁾-zeolite (6.9% Fe by weight) of Example 5 are mixed with 25 mg of NaCl, 22 mg of Na₂H₂P₂O₇ and 2 mg of NaH₂PO₄ in 1 ml of H₂O. The mixture is then exposed to air (20.7% O₂ concentration) in 100 ml sealed flasks provided with a septum that allows portions of the inside atmosphere to be drawn for analysis at several intervals using a syringe. Oxygen concentration measurements are carried out using a Mocon Pac Check 450® head space analyzer. The samples are not stirred or shaken during the course of the experiments. 1.0 ml of deionized H₂O is added through the silicon septum in the sealed flask with a syringe and the oxygen scavenger activity is evaluated as cc O₂/g of Fe after 48 hrs of reaction (measured from the moment when water is added to the system). The result is shown in Table 3.

TABLE 3

| cc O₂/g Fe present in the Zeolite*) | Standard deviation |
|---|---|
| 235 | 20 |

*)Volume of oxygen absorbed per g Fe as average of three experiments (Details are explained in Example 3.)

### EXAMPLE 8

NaCl, Na₂H₂P₂O₇ and NaH₂PO₄ are mixed with Riblene GP20® low density polyethylene so that the ratios NaCl/Na₂H₂P₂O₇/NaH₂PO₄ are 1/0.92/0.08 by weight, and the final concentration of NaCl is 1.2% by weight. 4.0% of Fe⁽⁰⁾-zeolite (Y-CBV 100) resulting in 0.25% of Fe by weight measured by ICP in the film are added. The mixtures are extruded in an OMC pilot double screw extruder (model EBV 19/25, with a 19 mm screw diameter and 1:25 ratio). 50 micron-thick films are prepared using a Formac Blow Extruder® (model Lab25, with a 22 mm screw diameter and 1:25 ratio). Several aliquots of film for each sample are then exposed to air (20.7% O₂) in 500 ml sealed flasks provided with a septum that allows portions of the inside atmosphere to be drawn for analysis at several intervals using a syringe, in the presence of 15 ml of water contained in a vial inside the flasks. Oxygen concentration measures are carried out using a Mocon Pac Check 450 head space analyzer over 28 days. The actual iron concentrations in the samples tested are finally also measured by ICP. The results in terms of cc O₂/g of Fe zeolite are given in Table 4.

TABLE 4

| Average cc O₂/g Fe Zeolite*) | Standard deviation |
|---|---|
| 130 | 20 |

*)Volume of oxygen absorbed per g Fe as average of five film experiments (Details are explained in Example 3; films thickness average: (52 ± 5) μm.)

### EXAMPLE 9

NaCl, Na₂H₂P₂O₇ and NaH₂PO₄ are mixed with Riblene GP20® low density polyethylene so that the ratios NaCl/Na₂H₂P₂O₇/NaH₂PO₄ are 1/0.92/0.08 by weight, and the final concentration of NaCl is 1.2% by weight. 4.0% of Fe⁽⁰⁾-zeolite (HSZ320) resulting in 0.27% of Fe by weight measured by ICP in the film are added. The mixtures are extruded in an OMC pilot double screw extruder (model EBV 19/25, with a 19 mm screw diameter and 1:25 ratio). 50 micron-thick films are prepared using a Formac Blow Extruder® (model Lab25, with a 22 mm screw diameter and 1:25 ratio). Several aliquots of film for each sample are then exposed to air (20.7% O₂) in 500 ml sealed flasks provided with a septum that allows portions of the inside atmosphere to be drawn for analysis at several intervals using a syringe, in the presence of 15 ml of water contained in a vial inside the flasks. Oxygen concentration measures are carried out using a Mocon Pac Check 450 head space analyzer over 28 days. The actual iron concentrations in the samples tested are finally also measured by ICP. The results in terms of ccO₂/g of Fe zeolite are given in Table 5.

TABLE 5

| Average cc O₂/g Fe Zeolite*) | Standard deviation |
|---|---|
| 95 | 15 |

*)Volume of oxygen absorbed per g Fe as average of five film experiments (Details are explained in Example 3; films thickness average: (52 ± 5) μm.)

1. An oxygen-scavenging mixture comprising the components
(I) a nano-sized oxidizable metal component wherein the average particle size of the metal is 1 to 1000 nm and wherein the metal is unsupported or supported by a carrier material,
(II) an electrolyte component, and
(III) a non-electrolytic, acidifying component.

2. The oxygen-scavenging mixture according to claim 1 wherein the average particle size of the metal is 1 to 100 nm and the metal is supported by a microporous material.

3. The oxygen-scavenging mixture according to claim 1 wherein the average particle size of the metal is 100 to 900 nm.

4. The oxygen-scavenging mixture according to claim 1 wherein the metal is selected from the group consisting of Al, Mg, Zn, Cu, Fe, Sn, Co and Mn.

5. The oxygen-scavenging mixture according to claim 1 wherein the metal is iron.

6. The oxygen-scavenging mixture according to claim 1 wherein the electrolyte component comprises sodium chloride.

7. The oxygen-scavenging mixture according to claim 1 wherein the non-electrolytic, acidifying component comprises sodium acid pyrophosphate and optionally NaH₂PO₄.

8. The oxygen-scavenging mixture according to claim 1 further comprising
(IV) a water-absorbant binder.

9. A composition comprising
(A) a polymeric resin, and
(B) an oxygen-scavenging mixture according to claim 1 and optionally a further additive selected from the group consisting of
(C-1) UV absorbers,
(C-2) antioxidants and
(C-3) further light stabilizers.

10. The composition according to claim 9 wherein the polymeric resin is an olefin homo- or copolymer, a thermoplastic resin, a polyamide homo or copolymer, a polyester with repeating units selected from the group consisting of therephthalic acid residues, isophtalic acid residues, naphthalenic acid residues and mixtures thereof.

11. An article containing a composition as defined in claim 9.

12. An article according to claim 11, which is a film, a sheet or a laminate.

13. An article according to claim 11 which is a food packaging.

14. A masterbatch comprising
(A) a polymeric resin, and
(B) 30 to 150% by weight, based on the polymeric resin, of the oxygen-scavenging mixture according to claim 1.

15. The use of a mixture comprising components (I) to (III) as defined in claim 1 as oxygen-scavenger in food packaging.
